(19) United States
(12) Patent Application Publication
(10) Pub. No.: US 2017/0221042 A1
(43) Pub. Date: Aug. 3, 2017

(54) INFORMATION SOURCE SELECTION FOR IDENTIFICATION AND VERIFICATION PROCESSES

(71) Applicant: MasterCard International Incorporated, Purchase, NY (US)

(72) Inventors: Janet Marie Smith, Ballwin, MO (US); Mark B. Wiesman, Chesterfield, MO (US); Kimberly Lewis Peyton, New York, NY (US)

(21) Appl. No.: 15/235,761

(22) Filed: Aug. 12, 2016

Related U.S. Application Data
(60) Provisional application No. 62/288,552, filed on Jan. 29, 2016.

(51) Int. Cl. G06Q 20/32; G06Q 20/10; G06Q 20/36

(52) U.S. Cl. CPC G06Q 20/3221; G06Q 20/367; G06Q 20/102

(57) ABSTRACT

A method includes receiving a request to provision a payment profile to a payment service facility. The method further includes determining source selection criteria applicable to the provisioning request. In addition, the method includes selecting an information source based at least in part on the determined source selection criteria. Still further, input is requested from the selected information source and is received from the selected information source. Based at least in part on the received input, decision-making is facilitated with respect to the provisioning request.

### CROSS REFERENCE TO RELATED APPLICATION

This application claims the benefit of U.S. Provisional Patent Application No. 62/288,552 filed on Jan. 29, 2016, the contents of which are hereby incorporated by reference for all purposes.

### BACKGROUND

One common manner of accessing payment accounts is by presenting a payment card at a point of sale in a retail store. On such occasions, payment credential information such as a payment account number (e.g., a PAN or “primary account number”) or a proxy for such as number (e.g., a payment token), and related information, may be read from the payment card by a POS terminal.

It has been proposed that mobile devices such as smartphones be used at the point of sale in lieu of a conventional payment card. For such purposes, mobile devices may be equipped with appropriate hardware features, such as circuitry for short-range radio data communications with the POS terminal or a reader component thereof. In addition, to enable the mobile device to function as a payment device, one or more payment application programs (“apps”) and one or more sets of payment credentials may be provisioned to the mobile device.

According to other proposals, payment credentials may be used for remote payments and may reside on a server. In addition or alternatively, payment details may be tokenized by using card-on-file tokens. In addition or alternatively, payment credentials for use by payment-enabled mobile devices may be stored in a remote server and made available for a transaction at the point of sale initiated by the payment-enabled mobile device.

For provisioning of payment credentials to smartphones, or for other arrangements in which payment credentials are digitized and stored in a device not directly under the account issuer's control, it is often deemed prudent to engage in what is called an “ID&V” process to provide reasonable assurance that the request for provisioning is for an authorized user of the payment account. As is well known to those skilled in the art, “ID&V” is an acronym that stands for “identification and verification”, i.e., verification of the requesting account holder's identity.

The concept of provisioning and need for associated ID&V processing may be applicable to contexts beyond those explicitly described above. For example, digitization of account credentials into a user's remotely stored digital wallet—maintained by a wallet service provider or “WSP”—may also call for ID&V to be performed. Similarly, in a service offering such as “InControl” (provided by MasterCard International Incorporated, which is the assignee hereof), it may be advisable to perform ID&V before implementing a request that a particular payment account be enrolled for the service offering. As is known to those skilled in the art, InControl may allow the account holder to apply limits and/or restrictions to the types of transactions for which an enrolled account may be used and/or may provide notifications to the account holder about some or all transactions as they occur.

The present inventors have now recognized opportunities to enhance the decision-making process that may be undertaken when a provisioning request is received.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram representation of a conventional payment system.

FIG. 2 is a block diagram representation of a system provided in accordance with aspects of the present invention.

FIG. 3 is a block diagram of a computer system that may provide part of the functionality of the system of FIG. 2 in accordance with aspects of the present invention.

FIG. 4 is a flow chart that illustrates a process that may be performed in the system of FIG. 2 in accordance with aspects of the present invention.

### DETAILED DESCRIPTION

In general, and for the purpose of introducing concepts of embodiments of the present invention, a provisioning request may trigger a process for determining one or more sources of information to be accessed to obtain information that may be useful for resolving the provisioning request. The process may include selecting from among sources of information based on one or more criteria applicable to the type of request and/or the nature of other relevant information that is already available. In some embodiments, once a source of information has been selected and queried, and a response received, there may be a further process to decide whether more information is needed and if so selection of one or more additional information sources may occur. The additional information source(s) selected may depend on the nature of the information provided by the first information source and/or an evaluation of how satisfactory the results of the first query were for supporting a reliable decision on the provisioning request.

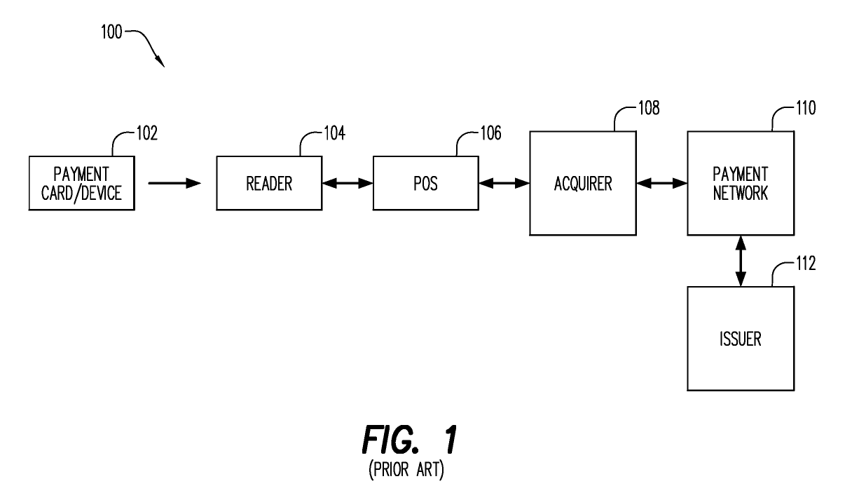

FIG. 1 is a block diagram of a conventional payment system 100.

The system 100 includes a conventional payment card/device 102. With pertinence to the present disclosure, the payment device 102 may be a payment-enabled mobile device that stores credentials for a number of payment accounts and runs a wallet app, as well as one or more payment apps. The system 100 further includes a reader component 104 associated with a POS terminal 106. In some known manner (depending on the type of the payment device 102) the reader component 104 is capable of reading the payment account number and other information from the payment device 102.

The reader component 104 and the POS terminal 106 may be located at the premises of a retail store and operated by a sales associate of the retailer for the purpose of processing retail transactions.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment devices for initiating payment transactions by presenting a payment account number to the reader component of a POS terminal.

Payment accounts are also widely used for e-commerce transactions, which are sometimes referred to as online shopping transactions. For a given transaction, a merchant's e-commerce server computer (not shown) may perform many of the roles of the POS terminal shown in FIG. 1, including initiation of a payment account transaction authorization request message. The payment account information may be supplied to the e-commerce server computer from the account holder, or may already be on file with the e-commerce server computer. According to some proposals, the payment account information for an e-commerce transaction may be provided from the account holder's digital wallet maintained by a WSP (not shown), which may thus also perform a role with respect to the transaction.

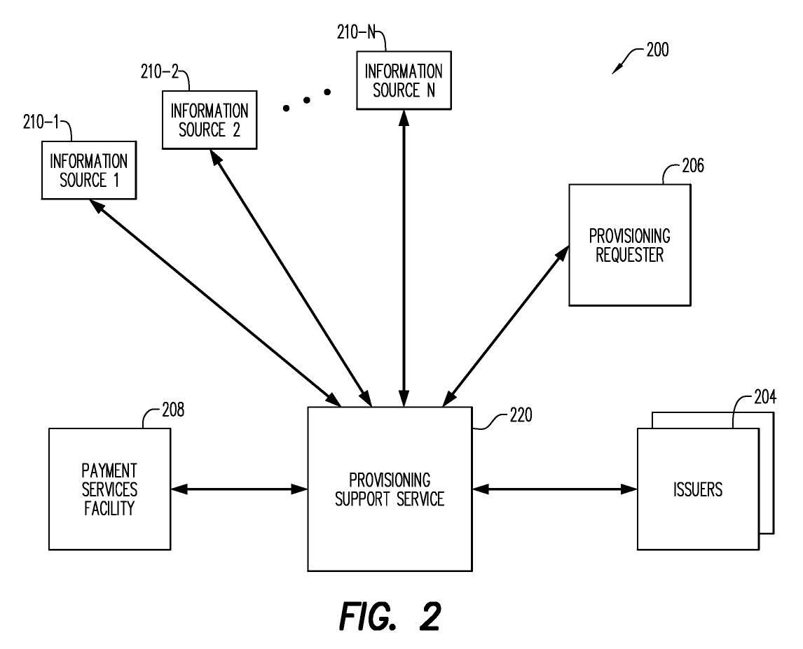

FIG. 2 is a block diagram representation of a system 200 provided in accordance with aspects of the present invention. A main purpose of the system 200 may be to handle requests for provisioning of payment credentials for one or more different types of purposes.

Block 202 in FIG. 2 represents a provisioning support service computer, which may support and/or perform decision-making with respect to provisioning requests. In some embodiments, the provisioning support service computer 202 may be operated by the operator of the payment network 110 (FIG. 1), or by an affiliate of the payment network operator. Details of an example embodiment of the provisioning support service computer 202 will be provided below.

Blocks 204 in FIG. 2 represent issuers of payment accounts and/or computers operated by such issuers. In some embodiments, the payment accounts issued by the issuers 204 are all branded under the auspices of the operator of the provisioning support service computer 202, but in other embodiments the payment accounts issued by the issuers 204, and/or which are subject to provisioning requests, include accounts branded in accordance with one or more other payment networks (not shown).

Block 206 in FIG. 2 represents an entity that transmits a provisioning request to the provisioning support service computer 202. In some embodiments, for example, the provisioning requester 206 may be a WSP that has an account holder's account information or at least a portion of the payment credentials that represent a payment account that is the subject of the provisioning request. The provisioning request may, for example, be in response to a request from the account holder (not shown) to digitize the payment credentials into the account holder's smartphone, which in the system of FIG. 2 is to be considered one example of a “payment service facility” (block 208), at least once the smartphone is enabled to have payment capabilities. In some embodiments, or in some situations, the payment service facility 208 may be a WSP and the provisioning requester 206 may be the account issuer for the payment account in question; the purpose of the request may be to digitize the payment credentials corresponding to the account into the account holder's digital wallet maintained in the WSP/payment service facility 208, and the request may be in response to interaction between the account holder and the account issuer, in which the account holder requested that the provisioning occur. In some cases, the provisioning requester 206 and the payment service facility 208 may be the same entity. For example, the requester 206/facility 208 may be a service, such as that described above, that provides an account holder with services that enable restrictions, controls and/or notifications with respect to a payment account.

Blocks 210-1, 210-2, . . . , 210-N represent sources of information that may receive queries from the provisioning support service computer 202 to obtain information in support of decision-making regarding provisioning requests. The information sources 210 may include one or more mobile network operators (MNOs) or entities that process and distribute information generated by or originating from MNOs; one or more credit bureaus; and/or one or more social media platforms. In addition or alternatively, the information sources 210 may include any entity that makes available information in one or more of the following categories: (i) social media data; (ii) location data; (iii) biometric information; (iv) life history information; (v) data relating to mobile devices; and (vi) identification/fingerprint data relating to digital/computing devices. It should be understood that the categories of information just listed are not necessarily mutually exclusive.

It should be noted that in a practical embodiment of the system 200, there may be numerous provisioning requesters, and numerous payment service facilities to which payment credentials may be provisioned.

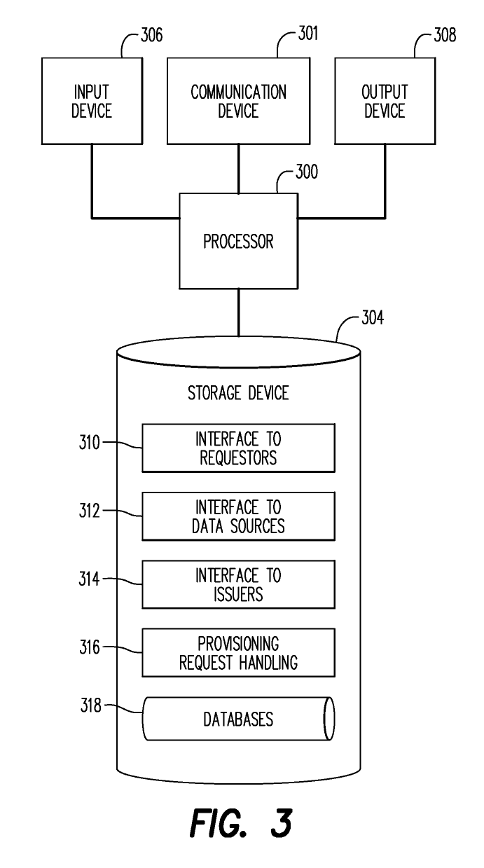

FIG. 3 is a block diagram that illustrates an example embodiment of the provisioning support service computer 202. The provisioning support service computer 202 may be constituted by server computer and/or mainframe computer hardware.

The provisioning support service computer 202 may include a computer processor 300 operatively coupled to a communication device 301, a storage device 304, an input device 306 and an output device 308. The computer processor may be in communication with the communication device 301, the storage device 304, the input device 306 and the output device 308.

The computer processor 300 may be constituted by one or more processors. Processor 300 operates to execute processor-executable steps, contained in program instructions described below, so as to control the provisioning support service computer 202 to provide desired functionality.

Communication device 301 may be used to facilitate communication with, for example, other devices (such as issuer computers 204 (FIG. 2), provisioning requesters, and/or payment service facilities). For example communication device 301 may comprise numerous communication ports (not separately shown), to allow the provisioning support service computer 202 to communicate simultaneously with a number of other devices and computers, including communications as required to receive and assist with and/or handle numerous provisioning requests.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

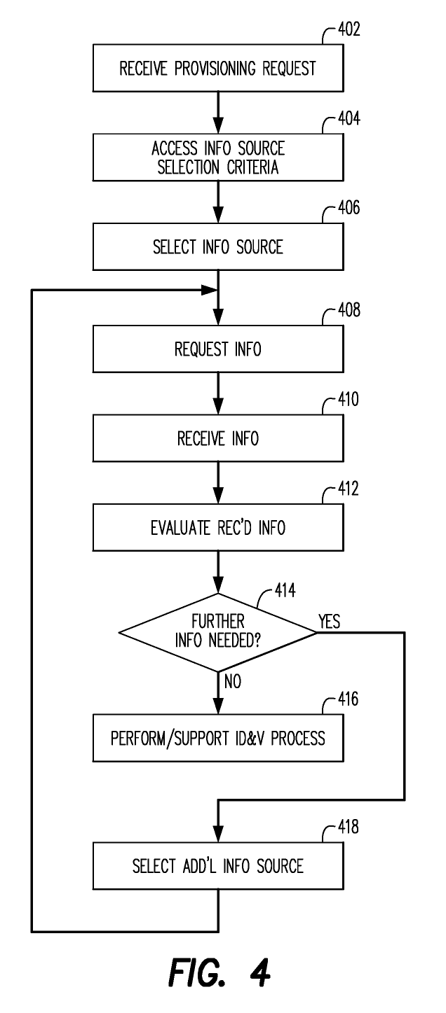

Storage device 304 stores one or more programs for controlling processor 300. The programs comprise program instructions (which may be referred to as computer readable program code means) that contain processor-executable process steps of the provisioning support service computer 202, executed by the processor 300 to cause the provisioning support service computer 202 to function as described herein. The functionality provided via the programs may include performing at least some of the process stages described below in connection with FIG. 4.

The programs stored by the storage device 304 may include one or more operating systems (not shown) that control the processor 300 so as to manage and coordinate activities and sharing of resources in the provisioning support service computer 202, and to serve as a host for application programs that run on the provisioning support service computer 202.

One program stored in the storage device 304 may be a software interface 310 to allow the provisioning support service computer 202 to interact with provisioning requesters. Another program stored in the storage device 304 may be a software interface 312 to allow the provisioning support service computer 202 to interact with the information sources 210 (FIG. 2). Yet another program stored in the storage device 304 may be a software interface 314 to allow the provisioning support service computer 202 to interact with the account issuers 204.

Still further, the storage device 304 may, for example, store a provisioning request handling application program 316. The provisioning request handling application program 316 may include instructions that program the processor 300 such that the provisioning support service computer 202 is enabled to handle payment credential provisioning requests in one or more of the manners described below.

The storage device 304 may further store database management programs and a reporting application (both not separately shown), the latter of which may respond to requests from system administrators for reports on the activities performed by the provisioning support service computer 202; the storage device 304 may also store communication software, device drivers, etc.

The storage device 304 may also store one or more databases 318 required for operation of the provisioning support service computer 202.

Computers operated by the issuers, the provisioning requester, the information sources and/or the payment services facility may have the same or similar sorts of hardware architecture, types of hardware components, and functions and interrelationships of components as described above with respect to the provisioning support service computer 202 illustrated in FIG. 3, except that the programming of those computers may be different from the manner in which the provisioning support service computer 202 is programmed.

FIG. 4 is a flow chart that illustrates an example process that may be implemented in some embodiments of the system 200 of FIG. 2.

At 402 in FIG. 4, a provisioning request is received by the provisioning support service computer 202. As will be understood from earlier discussion, the provisioning request may be received from the provisioning requester 206. The request may seek that payment credentials be provisioned to the payment services facility 208. In many situations, the provisioning requester 206 may be a WSP or one of the account issuers. The concept of provisioning has been described above; a more comprehensive definition of provisioning will be provided below. In some situations, the request contemplates that the provisioning support service computer 202 will fully perform the requested provisioning activity, including decision-making required to resolve the request (which may include either fulfilling the request or declining the request). In other situations, the provisioning support service computer 202 may only be expected to provide support for decision-making or a decision-making outcome, while the requester (e.g., the account issuer) will perform the actual provisioning based on the support or decision outcome provided by the provisioning support service computer 202. In some situations, in addition to performing the actual provisioning, the requester may also perform the actual decision making, based on information provided to the requester by the provisioning support service computer 202.

In the process of FIG. 4, block 404 may follow block 402. At block 404, the provisioning support service computer 202 may access one or more criteria to guide the determination by the provisioning support service computer 202 as to selection of an information source for the purpose of obtaining information relevant to the decision making on the provisioning request. The criteria may include one or more rules to guide the selection of the information source. In some situations one or more of the rules may have been previously prescribed or selected by the requester of the current request. The criteria may include, for example, the identity of the requester, the nature of the information provided in the request, the type of provisioning that is contemplated by the request, the cost of accessing particular information sources, the types of information available from the various information sources, the probable decision-making value/reliability of the information available from the various information sources (including, for example, conclusions and/or summary data from past experience in using one or more of the types of information in decision-making and the results of the decision-making), and/or the geographic region to which the provisioning request pertains (e.g., the country, continent or global region in which the payment account in question was issued). In some cases, for example, the information provided in the request may include the account holder's name and residence address and the PAN (primary account number) for the payment account for which provisioning is requested. In some cases, additional information may be included in the request, such as the account holder's mobile telephone number. In some cases, the request may include device identification and/or fingerprint information (e.g., in the case of a request to provision payment credentials to the account holder's mobile device), such as IMEI (international mobile equipment identity) data or MEID (mobile equipment identifier).

At block 406, based on the selection criteria accessed at 404, the provisioning support service computer 202 may select one information source from among the available information sources 210-1, 210-2, . . . , 210-N. (In some situations, the number of information sources available for possible selection may be two or more than two.)

At block 408, the provisioning support service computer 202 may transmit a request for information to the selected information source. For example, for some embodiments, and/or in some situations, the provisioning support service computer 202 may simply request that the information source 210 confirm one or more items of information received by the provisioning support service computer 202 in the provisioning request and relayed by the provisioning support service computer 202 to the information source 210. For example, in some situations, the provisioning support service computer 202 may request that the information source 210 confirm the validity of the account holder's mobile telephone number. In other embodiments, or in other situations, the provisioning support service computer 202 may request that the information source provide electronic contact information for the account holder, such as the account holder's e-mail address and/or mobile telephone number. In some embodiments, the provisioning support service computer 202 may request that the information source provide an account score (e.g., for the account holder's mobile telephone account) and/or a device score (e.g., for the account holder's mobile device). In other embodiments and/or situations, the provisioning support service computer 202 may request that the information source provide raw data concerning the account holder—such as the type of mobile telephone account held by the account holder, the length of time the account has been in effect, the status of the account, etc. In some embodiments, the provisioning support service computer 202 may request from the information source information concerning the account holder's social media activity, postings or profile; the account holder's life history; and/or the account holder's credit history.

At block 410, the provisioning support service computer 202 may receive the information requested at 408 from the information source selected at 406. It may be assumed that, in providing the requested information, the information source 210 was able to match the account holder information provided in the request at 408 with data concerning the account holder that was in the possession of the information source 210. If such a match failed to occur, the information source 210 may so advise the provisioning support service computer 202, which would mean that the request for information by the provisioning support service computer 202 was not successful.

At block 412, the provisioning support service computer 202 may evaluate the information it received at 410 from the information source selected at 406 and queried at 408. The provisioning support service computer 202 may apply one or more criteria and/or one or more protocols in evaluating the information received from the information source. For example, if the information request was a simple one—e.g., to receive confirmation of the account holder's mobile telephone number, or to receive the account holder's mobile telephone number (e.g., in cases where that information was not received as part of the provisioning request at 402)—and the information received complied with the request, then the provisioning support service computer 202 may conclude that the information request was successfully fulfilled. In some situations and/or embodiments, the only expectation from the provisioning requester may be that the provisioning support service computer 202 obtain or confirm the account holder's mobile telephone number and/or e-mail address, and relay the same to the provisioning requestor, so that the provisioning requester can send an activation code to the account holder using such information. From the provisioning requester's point of view, if the account holder then returns the activation code, ID&V can be considered to have been completed successfully or made unnecessary.

Continuing to consider possible embodiments of block 412, in other situations, the provisioning support service computer 202 may, for example, receive an account score and/or a device score from the information source. In some embodiments and/or situations, the only expectation from the provisioning requester may be that the provisioning support service computer 202 obtain and relay an account/device score to the provisioning requester. Thus, if the request by the provisioning support service computer 202 to the information source resulted in the provisioning support service computer 202 receiving this information, the provisioning support service computer 202 may conclude that the information request was successfully fulfilled. In subsequent processing, the provisioning support service computer 202 may relay the score or scores to the provisioning requester, which may use the same as an input or inputs to the provisioning requester's ID&V process or to the provisioning requester's decision making as to what type of ID&V process and/or which process steps or process paths to implement. In some embodiments, a like role may be performed by the provisioning support service computer 202 itself.

With still further consideration of possible embodiments of block 412, let it be assumed that the provisioning support service computer 202 is, in a given situation, charged with decision-making, and not just information gathering, with respect to the pending provisioning request. Consider further a situation in which the information requested and received consisted of an account score and/or a device score. In such situations, the provisioning support service computer 202 may evaluate whether the score(s) are highly favorable, mediocre, or poor. If the score(s) are highly favorable, the provisioning support service computer 202 may conclude that all information needed for decision-making has been obtained; if the score(s) are other than highly favorable, the provisioning support service computer 202 may conclude that further information is needed to support decision making on the pending provisioning request.

Considering once more possible embodiments of block 412, and assuming again that the provisioning support service computer 202 is charged with decision making in the situation at hand, assume that the information requested and received by the provisioning support service computer 202 from the information source 210 included raw account data, such as the type of mobile device account (e.g., pre-paid vs. post-paid), how long ago the account was established, and the account status (e.g., current and in good standing). Where the account information is strongly indicative of a legitimate account (e.g., post-paid, in effect for several years, current and in good standing), the provisioning support service computer 202 may conclude that sufficient information has been received to make a favorable decision on the pending provisioning request. When the account information is less strongly indicative of a legitimate account (e.g., a pre-paid account that was opened only a short time before), the provisioning support service computer 202 may conclude that further information should be obtained to support decision making on the pending provisioning request.

In the process of FIG. 4, a decision block 414 may follow block 412. At decision block 414, and based on the evaluation performed at 412, the provisioning support service computer 202 may decide whether further information is needed in support of decision making on the pending provisioning request. If not (i.e., if no further information is required and/or the role of the provisioning support service computer 202 in the process does not require it to gather more information), then block 416 may follow decision block 414. At block 416, the provisioning support service computer 202 may use the information received by its performance of the process to perform and/or support ID&V and/or other decision-making with respect to the pending provisioning request. For example, if the role of the provisioning support service computer 202 is to provide/gather information for the provisioning requester, then at 416 the provisioning support service computer 202 may relay the gathered information to the provisioning requester. As another example, if the roles of the provisioning support service computer 202 include both gathering information and decision-making (but not fulfillment of the provisioning request), then at 416 the provisioning support service computer 202 may provide a decision making outcome to the provisioning requester. (In one case of the latter example, the provisioning requester may be the account issuer and the provisioning support service computer 202 may indicate to the account issuer—in effect—one of the following: “OK to fulfill the provisioning request” or “Don't fulfill the provisioning request” or “engage in further verification with the account holder”.)

Continuing to consider possible embodiments of block 416, in some embodiments and/or situations, the provisioning support service computer 202 may be charged with information gathering, decision making and fulfillment with respect to the pending provisioning request. In such cases, the provisioning support service computer 202 activities at 416 may include fulfillment of the provisioning request as well as decision making.

Considering decision block 414 again, if a positive determination is made (i.e., if the provisioning support service computer 202 determines that more information gathering is required), then the process of FIG. 4 may advance from decision block 414 to block 418. At block 418, the provisioning support service computer 202 may select a further information source to be queried from among the information sources 210 (FIG. 2). In making this selection, the provisioning support service computer 202 may use one or more of the criteria discussed above in connection with block 406, as well as additional criteria, including criteria relating to the type and/or content of information received at 410. To give one illustrative example, where the information received at 410 includes a less than favorable account or device score and/or account information that does not strongly indicate that the account is legitimate, one or more information source selection rules may indicate that the provisioning support service computer 202 should select a credit bureau as a further information source.

With a further information source having been selected by the provisioning support service computer 202, the process of FIG. 4 may loop back to steps 408, 410, 412, etc. That is, the provisioning support service computer 202 may send an information request to, and receive back information from, the further information source. Moreover, the provisioning support service computer 202 may again evaluate the information received (this time, from the further information source; this time, in conjunction with information previously received) to determine whether still further information may be required. In some situations, the loop of blocks 408, 410, 412, 414, 418 may be repeated a number of times, until the information that has been gathered is deemed sufficient (or at least as good as it is feasible to gather). Once the information is deemed sufficient, or at a limit of what is feasible, then the process may branch to block 416, as referred to above.

With a provisioning support service computer 202 that performs information gathering as described above, the decision maker (the provisioning support service computer 202 or another entity, as the case may be) may often more readily reach a successful resolution of a provisioning request, in a time- and cost-efficient manner so that in a considerable number of cases the provisioning request can be fulfilled with an appropriate level of security and without requiring account holders to participate in a time-consuming interactive account holder authentication process. The information gathering process as described herein may be broadly applicable, in a number of different variations, to a wide range of different types of provisioning requests, including types described above and others referred to below.

As used herein and in the appended claims, provisioning a payment profile includes one or more of: (a) digitizing payment credentials into a mobile device; (b) making payment credentials accessible by use of a payment application on a mobile device with the payment credentials hosted on a remote server; (c) storing payment credentials in a server computer in an original or tokenized form for use in a remote payment transaction; (d) storing payment credentials in a digital wallet maintained for an account holder by a WSP; (e) enrolling a payment account in one or more services that apply controls, limits or reporting processes to use of the payment account; (f) enrolling an account holder in an authentication procedure to be applied to at least some transactions involving the account holder's payment account; and (g) enabling storage of biometric verification reference data with respect to a payment account. Any one or more of these types of provisioning may be the subject of a provisioning request as referred to above in connection with the process of FIG. 4.

As used herein and in the appended claims, a “payment profile” is any set or subset of information related to a payment account, and may include a PAN or payment token.

As used herein and in the appended claims, “payment token” has the same meaning as the term “Token” as defined in the “Payment Token Interoperability Standard” published in November 2013 by MasterCard, Visa and American Express.

As used herein and in the appended claims, the term “payment services facility” includes a payment-enabled mobile device, a WSP, and any other repository or entity to which a payment profile may be transmitted for storage.

As used herein and in the appended claims, “facilitating decision-making” should be understood to include performing or rendering unnecessary one or more steps in a decision-making process and/or gathering or receiving or confirming and/or supplying one or more data inputs used or required for a decision-making process.

As used herein and in the appended claims, a “request to provision” or a “provisioning request” may include a request for decision-making with respect to a provisioning request, and/or a request for information to facilitate such decision-making.

As used herein and in the appended claims, the term “criteria” should be understood to include the singular, i.e., “criterion.”

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow chart and description thereof herein should not be understood to prescribe a fixed order of performing the method steps described therein. Rather the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claim.

What is claimed is:

1. A method comprising:
receiving a request to provision a payment profile to a payment services facility;
determining source selection criteria applicable to the received provisioning request;
selecting an information source based at least in part on the determined source selection criteria;
requesting input from the selected information source;
receiving the requested input from the selected information source; and
facilitating decision-making with respect to the provisioning request based at least in part on said received input.

2. The method of claim 1, wherein the payment services facility is a payment-enabled mobile device.

3. The method of claim 2, wherein the payment profile includes payment credentials.

4. The method of claim 3, wherein the payment credentials include at least one of a PAN (primary account number) and a payment token.

5. The method of claim 1, wherein the payment services facility is a wallet service provider.

6. The method of claim 1, wherein the information source is (a) a source of data generated by a mobile network operator; (b) a credit bureau; or (c) a social media platform.

7. The method of claim 1, wherein the received input includes a customer account score or a device score.

8. The method of claim 1, wherein the received input includes a mobile telephone number or an e-mail address.

9. The method of claim 1, wherein said facilitating step includes using said received input to address a message to a user of a mobile device.

10. The method of claim 9, wherein the message includes an activation code.

11. The method of claim 1, wherein the facilitating step includes selecting a decision process or process path based on said received input.

12. The method of claim 1, wherein said facilitating step includes using said received input as an input to a decision-making process.

13. A method comprising:
receiving a request to provision a payment profile to a payment services facility;
receiving input from a first information source;
selecting a second information source based at least in part on said received input from the first information source;
requesting input from the second information source; and
facilitating decision-making with respect to the provisioning request based at least in part on said received input from the first information source and based at least in part on said received input from the second information source.

14. The method of claim 13, wherein the facilitating step includes selecting a decision process or process path based on said received input from the first information source and based on said received input from the second information source.

15. The method of claim 13, wherein the facilitating step includes using said received input from the first information source and said received input from the second information source as inputs to a decision-making process.

16. An apparatus comprising:
a processor; and
a memory in communication with the processor, the memory storing program instruction steps, the processor operative with the program instruction steps to perform functions as follows:
receiving a request to provision a payment profile to a payment services facility;
determining source selection criteria applicable to the received provisioning request;
selecting an information source based at least in part on the determined source selection criteria;
requesting input from the selected information source;
receiving the requested input from the selected information source; and
facilitating decision-making with respect to the provisioning request based at least in part on said received input.

17. The apparatus of claim 16, wherein the payment services facility is a payment-enabled mobile device.

18. The apparatus of claim 17, wherein the payment profile includes payment credentials.

19. The apparatus of claim 18, wherein the payment credentials include at least one of a PAN (primary account number) and a payment token.

20. The apparatus of claim 16, wherein the payment services facility is a wallet service provider.
